(19) United States
(12) Patent Application Publication
(10) Pub. No.: US 2010/0262537 A1
(43) Pub. Date: Oct. 14, 2010

(54) ARTIFICIAL INTELLIGENCE SETTLEMENT SYSTEM FOR OPTIMUM CARD RECOMMENDATION SERVICE AND PAYMENT APPARATUS AND COMBINATION CARD PAYMENT TERMINAL FOR THE SAME

(76) Inventor: Soo Min Park, Seoul (KR)

Correspondence Address: LRK Patent Law Firm, 1952 Gallows Rd, Suite 200, Vienna, VA, 22182, US

(21) Appl. No.: 12/676,859

(22) PCT Filed: Sep. 4, 2008
(86) PCT No.: PCT/KR08/05199

§ 371 Date: Jun. 22, 2010

(30) Foreign Application Priority Data
Sep. 7, 2007 (KR) 10-2007-0090867

(51) Int. Cl. G06Q 20/00; G06K 5/00; G06N 5/02

(52) U.S. Cl. 705/39; 235/380; 706/54

(57) ABSTRACT

Disclosed herein is an artificial intelligence payment system for recommending an optimum card capable of providing a maximum benefit from among a plurality of cards issued to a user. The artificial intelligence payment system includes a payment apparatus (110) for receiving an Identification (ID) of a combination card and payment amount information, transmitting the combination card ID and the payment amount information to an optimum card recommendation server (120), and receiving priority information based on benefits of a plurality of cards mapped to the combination card ID from the optimum card recommendation server. The optimum card recommendation server generates card priority information, which includes optimum card recommendation information, on a basis of benefits of respective cards and a specific optimum card recommendation algorithm with respect to the plurality of user cards mapped to the combination card ID, and provides the card priority information to the payment apparatus.

### TECHNICAL FIELD

The present invention relates, in general, to combination card payment, and, more particularly, to an artificial intelligence payment system for recommending an optimum card capable of providing the maximum benefit from among a plurality of cards issued to a user, and a payment apparatus and a combination card payment terminal for the artificial intelligence payment system.

### BACKGROUND ART

Currently, most card users each carry various types of cards, such as a credit card, a department store card, a debit card, a discount card, and a membership card, each providing various different types of benefits.

However, since it is difficult for users to know all the benefits of respective cards, there is a very low probability that each user uses a suitable card capable of providing the maximum benefit. In most cases, a user uses his or her most commonly used card, regardless of the benefits of respective cards because it is difficult to learn and use the benefits of the respective cards.

Further, the benefits of respective cards are not fixed, but are changed after a predetermined period of time has elapsed. Accordingly, it is almost impossible for each user to precisely learn information about the benefits of the respective cards carried by the user in real time, and this becomes a principal cause to prevent each card user from suitably using the benefits of his or her cards.

Meanwhile, in order to overcome an inconvenience in which a user carries a plurality of cards in his or her wallet, the application of various patents and the development of various technologies related to a combination card method, which enables a plurality of cards to be collected as a single card and to be used, have recently been conducted.

However, such a combination card method proposed in the prior art merely overcomes the inconvenience occurring when a user carries a plurality of cards, and does not provide a method of suitably using benefits assigned to respective cards at the present time.

### DISCLOSURE OF INVENTION

### Technical Problem

Accordingly, the present invention has been made keeping in mind the above problems occurring in the prior art, and an object of the present invention is to provide an artificial intelligence payment system, which recommends an optimum payment means, that is, an optimum card, by automatically searching and comparing benefits provided by respective cards while overcoming the physical inconvenience occurring when a user carries a plurality of cards, and a payment apparatus and a combination card payment terminal for the artificial intelligence payment system.

Another object of the present invention is to provide an artificial intelligence payment system, which recommends an optimum card according to predetermined criteria, but recommends an optimum card using a user's own optimum card recommendation algorithm by being fed back with user preference information, such as information about a card actually selected by the user, and a payment apparatus and a combination card payment terminal for the artificial intelligence payment system.

### Technical Solution

In accordance with an aspect of the present invention to accomplish the above objects, there is provided an artificial intelligence payment system for recommending an optimum card capable of providing a maximum benefit from among a plurality of cards, comprising a payment apparatus for receiving an Identification (ID) of a combination card, which enables a plurality of cards to be used as a single card, and information about a payment amount, transmitting the combination card ID and the payment amount information to an optimum card recommendation server, and receiving priority information based on benefits of a plurality of cards mapped to the combination card ID from the optimum card recommendation server; and the optimum card recommendation server for generating card priority information, which includes optimum card recommendation information, on a basis of benefits of respective cards and a specific optimum card recommendation algorithm with respect to the plurality of user cards mapped to the combination card ID when the combination card ID and the payment amount information are received from the payment apparatus, and for providing the card priority information to the payment apparatus.

Preferably, the payment apparatus processes payment using an optimum card on a basis of the card priority information received from the optimum card recommendation server.

Preferably, the payment apparatus presents the card priority information, received from the optimum card recommendation server, to the user by outputting the card priority information, and then processes payment using a card selected by the user from among the plurality of cards.

Preferably, the payment apparatus transmits information about the card selected by the user to the optimum card recommendation server, and the optimum card recommendation server determines criteria by which the user selects a card on a basis of the information about the card selected by the user, updates priority information of the user for selection of a card according to the criteria, and generates the card priority information for the user on a basis of an optimum card recommendation algorithm, in which the updated priority information of the user is considered.

In accordance with another aspect of the present invention to accomplish the above objects, there is provided an artificial intelligence payment system for recommending an optimum card capable of providing a maximum benefit from among a plurality of cards, comprising a payment apparatus for transmitting an ID of a combination card, which enables a plurality of cards to be used as a single card, to an optimum card recommendation server, and receiving information about a plurality of cards mapped to the combination card ID from the optimum card recommendation server when the combination card ID and information about a payment amount are input, and for generating card priority information, which includes optimum card recommendation information, on a basis of benefits of respective cards and a specific optimum card recommendation algorithm, with respect to the plurality of user cards; and the optimum card recommendation server for providing the information about the plurality of user cards mapped to the combination card ID to the payment apparatus when the combination card ID is received from the payment apparatus.

Preferably, the payment apparatus processes payment using an optimum card on a basis of the generated card priority information.

Preferably, the payment apparatus presents the generated card priority information to the user by outputting the priority information, and then processes payment using a card selected by the user from among the plurality of cards.

Preferably, the payment apparatus transmits information about the card selected by the user to the optimum card recommendation server, and generates card priority information on a basis of an optimum card recommendation algorithm, in which priority information of the user is considered, when the priority information of the user is received together with the information about the plurality of cards mapped to a specific combination card ID from the optimum card recommendation server.

Preferably, the optimum card recommendation server determines criteria by which the user selects a card on a basis of the information about the card selected by the user, updates priority information of the user for selection of a card according to the criteria, and provides updated priority information of the user to the payment apparatus when the combination card ID of the user is subsequently received.

In accordance with a further aspect of the present invention to accomplish the above objects, there is provided an artificial intelligence payment system for recommending an optimum card capable of providing a maximum benefit from among a plurality of cards, comprising a payment apparatus for obtaining information about a plurality of cards from a combination card, in which information about a plurality of cards is recorded, transmitting the obtained card information and information about a payment amount to an optimum card recommendation server, and receiving priority information based on benefits of respective cards from the optimum card recommendation server; and the optimum card recommendation server for generating card priority information, which includes optimum card recommendation information, on a basis of the benefits of the respective cards and a specific optimum card recommendation algorithm with respect to the plurality of cards, and providing the card priority information to the payment apparatus when the information about the plurality of cards and the payment amount information are received from the payment apparatus.

Preferably, the payment apparatus processes payment using an optimum card on a basis of the card priority information received from the optimum card recommendation server, or processes payment using a card selected by the user from among the plurality of cards by presenting the card priority information, received from the optimum card recommendation server, to the user.

Preferably, the payment apparatus transmits the information about the card selected by the user to the optimum card recommendation server; and the optimum card recommendation server determines criteria by which the user selects a card on a basis of the information about the card selected by the user, updates priority information of the user for selection of a card according to the criteria, and subsequently generates card priority information for the user on a basis of an optimum card recommendation algorithm in which the updated priority information of the user is considered.

In accordance with yet another aspect of the present invention to accomplish the above objects, there is provided an artificial intelligence payment system for recommending an optimum card capable of providing a maximum benefit from among a plurality of cards, comprising a payment apparatus for transmitting obtained information about a plurality of cards to an optimum card recommendation server and receiving priority information of a user for selection of a card from the optimum card recommendation server when the information about the plurality of cards is obtained from a combination card in which information about the plurality of cards is recorded, and information about a payment amount is received, and for generating card priority information, which includes optimum card recommendation information, on a basis of benefits of respective cards and an optimum card recommendation algorithm, in which the priority information of the user is considered; and the optimum card recommendation server for providing the priority information of the user to the payment apparatus when the information about the plurality of cards is received from the payment apparatus.

Preferably, the payment apparatus processes payment using an optimum card on a basis of the generated card priority information, or processes payment using a card selected by the user from among the plurality of cards by presenting the generated card priority information to the user.

Preferably, the payment apparatus transmits information about the card used for payment among the plurality of cards to the optimum card recommendation server; and the optimum card recommendation server determines criteria by which the user selects a card on a basis of the information about the card used for payment, updates priority information of the user for selection of a card according to the criteria, and provides the updated priority information of the user to the payment apparatus when the combination card of the user is subsequently used.

In accordance with still another aspect of the present invention to accomplish the above objects, there is provided a payment apparatus for processing payment using a combination card, enabling a plurality of cards to be used as a single card, and recommending an optimum card capable of providing a maximum benefit from among a plurality of cards usable for a single combination card, wherein when information about a combination card and information about a payment amount are input, the payment apparatus presents card priority information, which includes optimum card recommendation information and is generated on a basis of benefits of respective cards and a specific optimum card recommendation algorithm with respect to the plurality of user cards usable for the combination card, to a user, and processes payment using a card selected by the user from among the plurality of user cards.

Preferably, the payment apparatus transmits the combination card information and the payment amount information to the specific optimum card recommendation server, receives the card priority information from the optimum card recommendation server, and presents the card priority information to the user.

Preferably, the payment apparatus transmits information about the card used for payment to the optimum card recommendation server, and receives card priority information, based on an optimum card recommendation algorithm, in which priority information of the user for selection of a card according to the card information selected by the user is considered, from the optimum card recommendation server when the combination card of the user is subsequently used.

Preferably, the payment apparatus stores the optimum card recommendation algorithm, and directly generates the card priority information.

Preferably, the payment apparatus transmits the information about the card used for payment to the optimum card recommendation server, and receives priority information of the user for selection of a card according to the card information selected by the user from the optimum card recommendation server when the combination card of the user is subsequently used, and then generates card priority information on a basis of an optimum card recommendation algorithm in which the priority information is considered.

In accordance with still another aspect of the present invention to accomplish the above objects, there is provided a combination card payment terminal of a user for using a payment apparatus for recommending an optimum card capable of providing a maximum benefit from among a plurality of cards carried by the user, comprising memory for storing information about the plurality of cards carried by the user; and communication means for transmitting the information about the plurality of cards, stored in the memory, to the payment apparatus in response a payment request received from the user, wherein the combination card payment terminal enables an optimum card recommended by the payment apparatus, among the plurality of cards, to be used for payment.

In accordance with still another aspect of the present invention to accomplish the above objects, there is provided a combination card payment terminal of a user for recommending an optimum card capable of providing a maximum benefit from among a plurality of cards carried by the user, comprising memory for storing information about the plurality of cars carried by the user, information about benefits of respective cards, and a predetermined optimum card recommendation algorithm; communication means for transmitting information about a card selected by the user among pieces of information about the plurality of cards, stored in the memory, to a payment apparatus; a combination card information management unit for managing the card information stored in the memory; and an optimum card recommendation unit for generating and outputting card priority information, which includes optimum card recommendation information, on a basis of the information about the benefits of respective cards and the optimum card recommendation algorithm, which are stored in the memory, and performing control such that, when the user selects a card to be used for payment, information about the selected card is transmitted to the payment apparatus through the communication means, wherein the combination card payment terminal enables an optimum card selected from among the plurality of cards to be used for payment.

Preferably, the optimum card recommendation unit determines criteria by which the user selects a card on a basis of the information about the card selected by the user, manages priority information of the user for selection of a card according to the criteria, and generates card priority information by enabling the priority information of the user to be considered in the optimum card recommendation algorithm.

Preferably, the combination card payment terminal further comprises an update unit for downloading the information about the benefits of respective cards and the optimum card recommendation algorithm, which are stored in the memory, over wired/wireless Internet, and updating the downloaded information and algorithm.

### ADVANTAGEOUS EFFECTS

In accordance with an artificial intelligence payment system for recommending an optimum card, and a payment apparatus and a combination card payment terminal for the payment system according to the present invention, there are advantages in that an optimum payment means, that is, an optimum card, can be recommended by automatically searching and comparing benefits provided by respective cards, while a physical inconvenience occurring when a user carries a plurality of cards can be overcome, thus enabling a card having the maximum benefit to be used for payment even if a user issued with a plurality of cards is not personally aware of the benefits of respective cards, or does not individually compare the benefits with each other.

Furthermore, in accordance with the present invention, there are advantages in that an optimum card is recommended according to predetermined criteria, and the recommendation is made using a user's own optimum card recommendation algorithm by feed-back of information about a card actually selected by the user, thus enabling an optimum card in which the user's preference is considered to be recommended.

### BRIEF DESCRIPTION OF THE DRAWINGS

FIG. 1 is a network configuration diagram showing an artificial intelligence payment system for recommending an optimum card according to an embodiment of the present invention;

FIG. 2 is a diagram showing the construction of an optimum card recommendation server according to an embodiment of the present invention;

FIG. 3 is a flowchart showing the operation of an artificial intelligence payment system for recommending an optimum card according to an embodiment of the present invention;

FIG. 4 is a diagram showing the construction of a POS terminal according to an embodiment of the present invention;

FIG. 5 is a diagram showing the construction of an optimum card recommendation server according to another embodiment of the present invention;

FIG. 6 is a flowchart showing the operation of an artificial intelligence payment system for recommending an optimum card according to another embodiment of the present invention;

FIG. 7 is a network configuration diagram showing an artificial intelligence payment system for recommending an optimum card according to a further embodiment of the present invention;

FIG. 8 is a network configuration diagram showing a combination card payment terminal according to an embodiment of the present invention;

FIG. 9 is a diagram showing the construction of a combination card payment terminal according to an embodiment of the present invention; and

FIG. 10 is a flowchart showing the operation of a combination card payment terminal according to an embodiment of the present invention.

### BEST MODE FOR CARRYING OUT THE INVENTION

The above objects, technical constructions, operations and advantages of the present invention will be more clearly understood from the following detailed description taken in conjunction with the accompanying drawings.

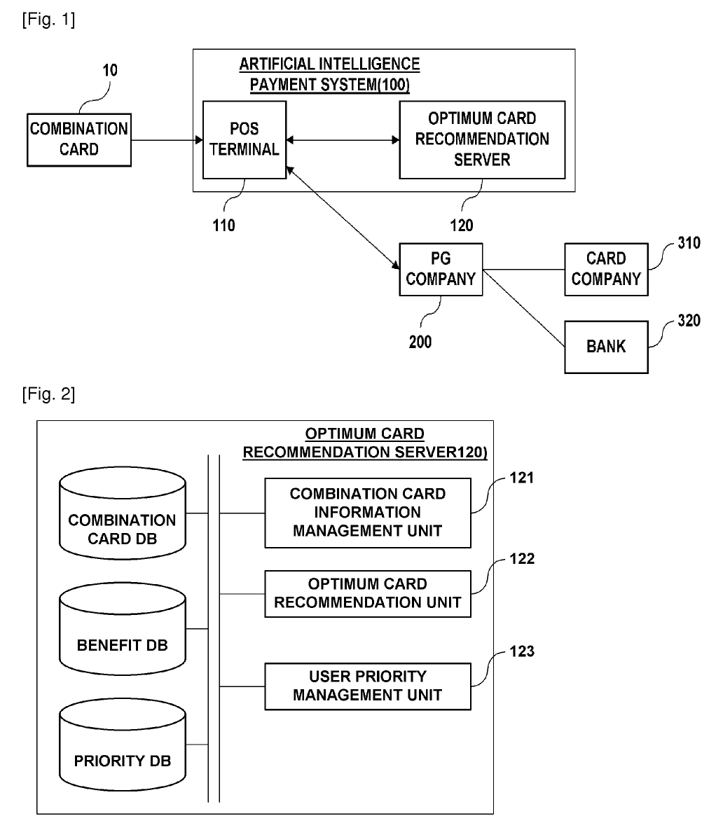

FIG. 1 is a network configuration diagram showing an artificial intelligence payment system for recommending an optimum card according to an embodiment of the present invention.

As shown in the drawing, an artificial intelligence payment system 100 for recommending an optimum card according to the present invention includes a Point Of Sale (POS) terminal 110 as a payment apparatus, and an optimum card recommendation server 120.

The POS terminal 110 permits payment using a combination card 10 which is implemented to allow a user to use a plurality of cards issued thereto as a single card, and communicates with a Payment Gateway (PG) company 200, which is a payment agent institution for interfacing with payment institution such as a card company 310 and a bank 320.

The combination card 10 may be a card in which a combination card ID (or a user ID) functioning as a medium for enabling information about a plurality of cards carried by the user to be obtained is recorded, a card which is set as a combination card among a plurality of cards carried by the user, or a separate card in which information about all cards carried by the user is recorded.

Further, the combination card in the present invention is not limited to a card having a physical card shape, and may include all storage devices having a payment function regardless of the physical shape thereof. That is, the term “combination card” in the present invention means all means capable of providing a combination card ID to the POS terminal.

Further, the POS terminal 110 may obtain information recorded on the combination card 10 by reading the information from the combination card 10 in a contact manner or a non-contact manner, and may obtain information about a plurality of user cards mapped to a relevant combination card ID by transmitting the combination card ID to the optimum card recommendation server 120 when, in the combination card, only the combination card ID is recorded.

Meanwhile, the combination card 10 may be issued from a financial institution or each affiliated store, and may be implemented using a method in which the user is personally issued with a combination card and registers the combination card through the Internet using a card reader and a PC.

Further, although not shown in detail in the drawing, the POS terminal 110 may directly receive a combination card ID from the user. In this case, the user may use a combination card payment method according to the present invention without requiring possession of the combination card 10. At this time, the combination card ID, directly received from the user, may be information acquired through biometrics. That is, the user can provide a combination card ID (biometric data) to the POS terminal 110 using biometrics based on a fingerprint or an iris scan.

Meanwhile, in this embodiment, the POS terminal 10 obtains information about a plurality of cards carried by the user through the optimum card recommendation server 120, and obtains both information about an optimum card, set based on the benefits of respective cards and a specific optimum card recommendation algorithm, and card priority information, which includes the optimum card information. In this case, the POS terminal 110 presents the obtained card priority information to the user, and thereafter processes payment using a card selected by the user. According to the circumstances, the POS terminal 10 may automatically process payment using an optimum card with the user's previous assent.

Further, the optimum card recommendation algorithm described in the present invention may be implemented using various methods. For example, of a credit card, a debit card and a check card, the credit card can be recommended to have the highest priority and the debit card or the check card can be recommended to have the next highest priority so that the largest interest rate benefit is given to the user. Of a cash discount and a point accumulation benefit, the cash discount can be selected to have the highest priority, and the point accumulation benefit can be selected to have the next highest priority. When, for several cards, a cash discount is given by the same amount of money, a card having a higher discount limit or a card having a larger point accumulation benefit can be selected to have the highest priority. Further, of cards having the point accumulation benefit, cash points are selected to have the highest priority, and airplane mileages are selected to have the next highest priority, so that the optimum card recommendation algorithm is preferably implemented to recommend a card having better conditions according to the level of utilization.

Further, the term “combination card” described in the present invention means a card that enables a discount card, such as a mileage card and a membership card, as well as a payment card, such as a credit card, a debit card and a check card, to be used in a combination manner. The optimum card recommendation algorithm may recommend a combination of the payment card and the discount card as an optimum card. That is, in the present invention, the optimum card may be a combination of a plurality of cards.

Meanwhile, the present invention may recommend an optimum card to each user using an optimum card recommendation algorithm, in which the user's preference is considered in a basically designated default algorithm. For this operation, in the present embodiment, the POS terminal 110 transmits information about a card, finally used for payment by the user, to the optimum card recommendation server 120. The optimum card recommendation server 120 learns on the basis of the received card information the criteria by which the user selects a card, updates the priority of the user (benefits prioritized by the user at the time of selecting a card), and subsequently uses for a relevant user an optimum card recommendation algorithm in which the relevant user's priority is considered.

According to the circumstances, the user may directly access the optimum card recommendation server 120 and designate the priorities of the user's cards, and may directly provide information about cards to be used among the cards issued to the user to the optimum card recommendation server 120.

FIG. 2 is a diagram showing the construction of an optimum card recommendation server according to an embodiment of the present invention.

As shown in FIG. 2, the optimum card recommendation server 120 includes a combination card information management unit 121, an optimum card recommendation unit 122, and a user priority management unit 123.

The combination card information management unit 121 is a block for storing and managing in a combination card Database (DB) information about a plurality of cards related to the combination card ID of each user. The combination card information management unit 121 may directly receive registration of the information about the plurality of cards carried by each user from the user, or may be provided with the card information in cooperation with financial institutions or affiliated stores. Further, the combination card information management unit 121 may provide information about cards carried by the user to the payment apparatus, such as the POS terminal 110 or to the PG company 200.

The optimum card recommendation unit 122 is a block for generating priority information related to the use of a plurality of cards carried by a user on the basis of the benefits of respective cards stored in a benefit DB, the optimum card recommendation algorithm, the priority information of the user required to consider the user's preference, affiliated store information, and payment amount information, and providing the generated card priority information to the payment apparatus such as the POS terminal 110 when the user is about to pay using the combination card.

In this case, the card priority information generated by the optimum card recommendation unit 122 contains information about an optimum card set according to predetermined criteria, and may contain priority information varying according to various criteria, such as priority information, designated for example in the order of cash discounts or in the order of point accumulation benefits.

Therefore, the payment apparatus provides the card priority information generated by the optimum card recommendation unit 122 to the user, but it is also possible to change criteria order with regards to cash discounts or the point accumulation benefits at the request of the user and to automatically provide cards set according to the changed criteria, thus allowing the user to personally select an optimum card on the basis of his or her desired benefit.

Meanwhile, in the present embodiment, the optimum card recommendation server 120 manages information about the benefits of respective cards in the benefit DB, but the benefit information of respective cards may also be stored in the combination card or the payment apparatus. That is, in the present invention, a location at which the benefit information of respective cards is stored, or a method of obtaining the benefit information is not limited.

Next, the user priority management unit 123 receives information about a card actually used by the user for payment from the payment apparatus, learns information about the criteria by which the user selects a card, and updates the user's own priority information in a priority DB in real time on the basis of the criteria information. Further, the optimum card recommendation unit 122 executes an optimum card recommendation algorithm, in which the user's preference is considered, using the priority DB.

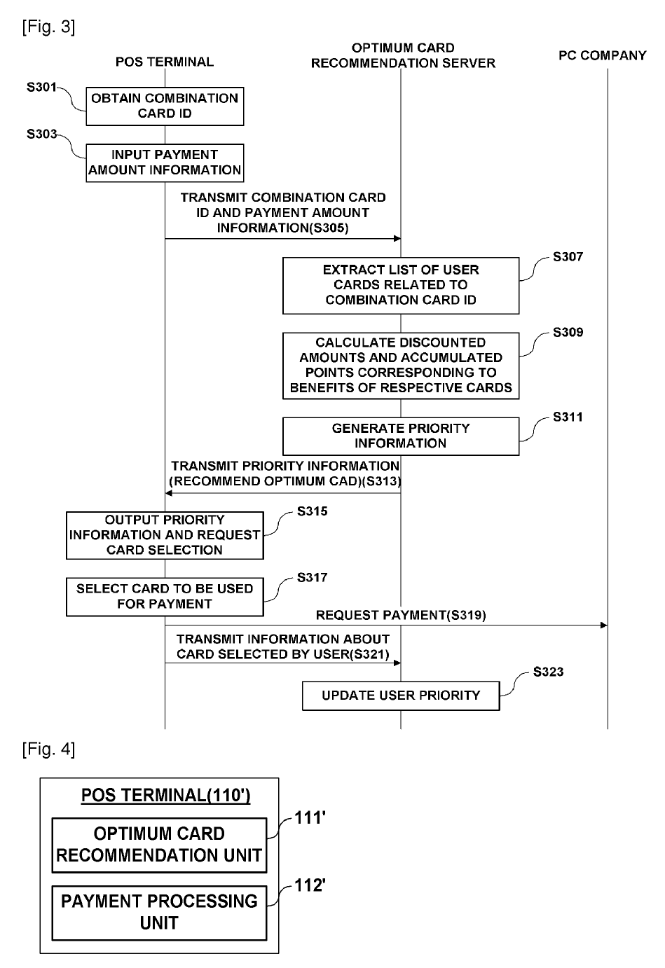

FIG. 3 is a flowchart showing the operation of the artificial intelligence payment system for recommending an optimum card according to an embodiment of the present invention.

As shown in FIG. 3, the POS terminal obtains a combination card ID at step S301. When information about a payment amount is input from an affiliated store at step S303, the POS terminal transmits both the combination card ID and the payment amount information to the optimum card recommendation server at step S305.

The optimum card recommendation server extracts a list of user cards related to the combination card ID, that is, information about a plurality of cards carried by the user, at step S307, calculates, for respective cards, discounted amounts or accumulated points corresponding to the benefits of respective cards at step S309, and generates card priority information, which includes optimum card information, by applying the calculated information to the optimum card recommendation algorithm at step S311.

The card priority information is transmitted to the POS terminal at step S313. The POS terminal requests the user to select a card to be used for payment by outputting the received priority information at step S315. When the user selects a card to be used for payment at step S317, the POS terminal requests the PG company to process payment by transmitting information about the selected card to the PG company at step S319. In addition, the POS terminal transmits the information about the card used for payment to the optimum card recommendation server at step S321. Accordingly, the optimum card recommendation server updates the priority of the user to subsequently consider the user's preference at step S323. For example, when, on the basis of the previously generated priority information, the card used by the user for payment is a card which offers the highest percentage cash discount, the optimum card recommendation server may store ‘cash’ as the priority information of the relevant user. Further, when the card selected by the user is a card which accumulates the highest percentage of points, the optimum card recommendation server may store ‘point’ as the priority information of the user.

FIG. 4 is a diagram showing the construction of a POS terminal according to an embodiment of the present invention.

A POS terminal 110′ according to the present embodiment is a payment apparatus for directly executing an optimum card recommendation algorithm and recommending an optimum card, and may include an optimum card recommendation unit 111′ and a payment processing unit 112′.

When information about a plurality of cards of the user is obtained through a combination card, and payment amount information is input, the optimum card recommendation unit 111′ transmits the obtained card information to the optimum card recommendation server 120′, receives priority information of the user for the selection of a card from the optimum card recommendation server 120′, generates card priority information, which includes optimum card recommendation information, on the basis of the benefits of respective cards and an optimum card recommendation algorithm, in which the priority information of the user is considered, and provides the card priority information to the user.

When a specific card is selected by the user after the card priority information has been provided to the user by the optimum card recommendation unit 111′, the payment processing unit 112′ requests the PG company to process payment by transmitting information about the selected card to the PG company. In this case, the payment processing unit 112′ transmits the information about the card used for payment to the optimum card recommendation server 120′. Accordingly, the optimum card recommendation server 120′ manages the user priority information, which is a criterion by which each user selects a card, and subsequently provides the user priority information to the POS terminal 110′.

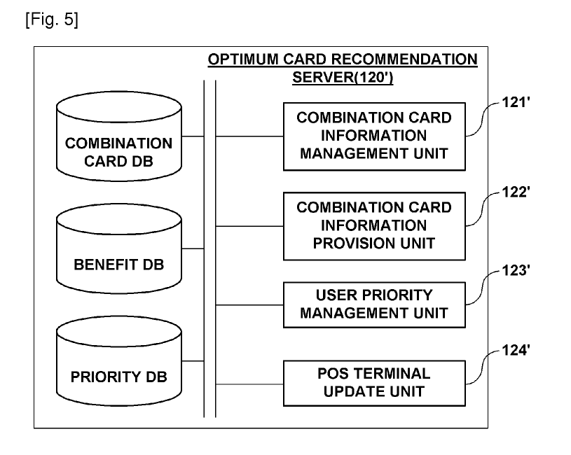

FIG. 5 is a diagram showing the construction of an optimum card recommendation server according to another embodiment of the present invention.

An optimum card recommendation server 120′ according to this embodiment is a server operating in conjunction with the POS terminal 110′ of FIG. 4, and may include a combination card information management unit 121′, a combination card information provision unit 122′, a user priority management unit 123′, and a POS terminal update unit 124′.

The combination card information management unit 121′ is a block for storing and managing in a combination card DB information about a plurality of cards related to the combination card ID of each user. The combination card information management unit 121′ may directly receive registration of the plurality of cards carried by each user from the user, or may be provided with the card information in cooperation with financial institutions or affiliated stores.

Further, the combination card information management unit 121′ may provide information about a plurality of cards carried by the user to a payment apparatus, such as the POS terminal 110′, or to the PG company.

If a combination card ID is received from the POS terminal 110′ when the user is about to pay using the combination card, the combination card information provision unit 122′ extracts information about the plurality of cards carried by the relevant user from a combination card DB and provides the extracted card information to the POS terminal 110′. In this embodiment, since the POS terminal 110′ executes an optimum card recommendation algorithm, the combination card information provision unit 122′ must provide user priority information (information about the criteria by which the user selects a card) that is managed in a priority DB, together with the card information.

The user priority management unit 123′ learns the information about the criteria by which the user selects a card by receiving the information about the card actually used by the user from the payment apparatus, such as the POS terminal 110′, and then updates the user's own priority information in the priority DB in real time on the basis of the criteria information.

The POS terminal update unit 124′ manages a benefit DB, downloads information about the benefits of respective cards to the POS terminal 110′ of each affiliated store either in the event of the change of information stored in the benefit DB or periodically, and updates data related to a relevant optimum card recommendation algorithm in the POS terminal 110′ when the optimum card recommendation algorithm is changed.

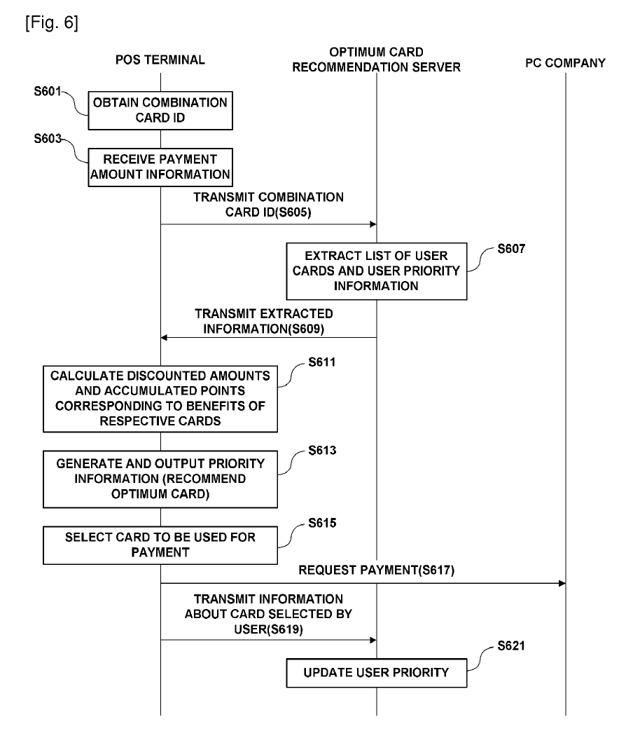

The flowchart of the operation of the artificial intelligence payment system, implemented to recommend an optimum card and related to the embodiments of FIGS. 4 and 5, is shown in FIG. 6.

As shown in the drawing, when the POS terminal obtains a combination card ID and receives payment amount information at steps S601 and S603, the POS terminal transmits the combination card ID to the optimum card recommendation server, thus requesting the optimum card recommendation server to transmit information about a plurality of cards carried by the user and user priority information at step S605. The optimum card recommendation server extracts the card information and the user priority information from the combination card DB and the priority DB at step S607, respectively, and transmits the extracted information to the POS terminal at step S609.

The POS terminal calculates various types of information required for the setting of priority, such as discounted amounts and accumulated points for respective cards, on the basis of information about preset benefits of respective cards at step S611, and generates and outputs priority information by executing an optimum card recommendation algorithm depending on the calculated information at step S613.

Further, when the user selects a card to be used for payment at step S615, the POS terminal requests the PG company to process payment by transmitting the information about the selected card to the PG company at step S617. Further, the POS terminal also provides the information about the card selected by the user to the optimum card recommendation server at step S619, thus enabling the optimum card recommendation server to manage the priority information of the user at step S621.

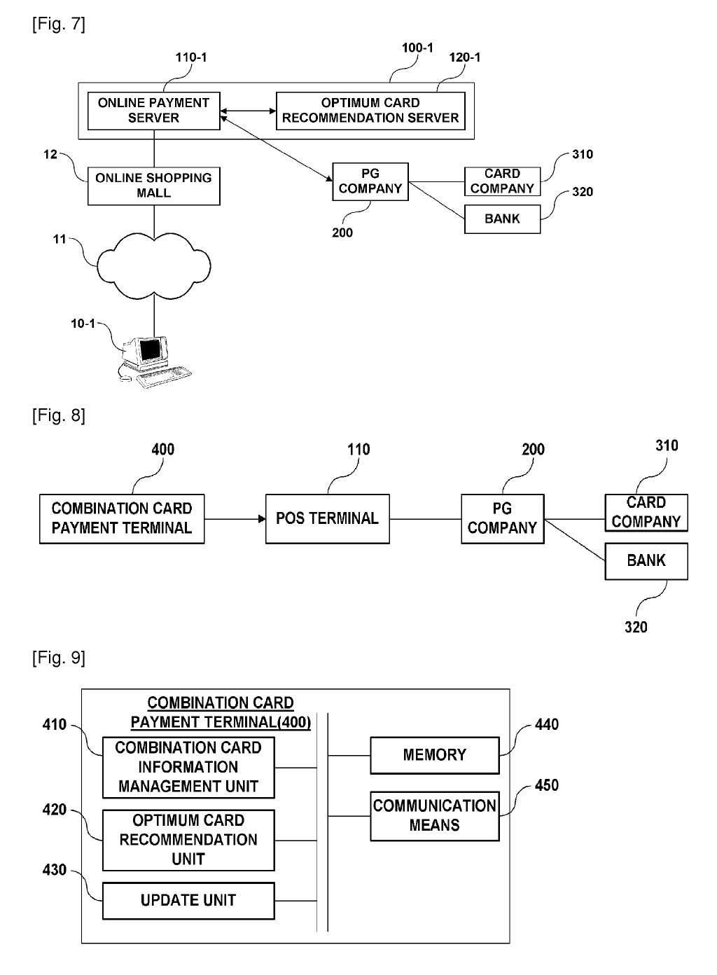

FIG. 7 is a network configuration diagram showing an artificial intelligence payment system for recommending an optimum card according to a further embodiment of the present invention.

The above-described embodiments are related to the cases using the POS terminals of offline affiliated stores, but a payment apparatus described in the present invention can also be applied to online systems.

That is, an artificial intelligence payment system 100-1 according to the present invention may include an online payment server 110-1 as a payment apparatus, and an optimum card recommendation server 120-1. The online payment server 110-1 is a server which takes charge of combination card payment for the selling of products occurring in an online shopping mall 12 or the like.

For example, when the user requests combination card payment from the online shopping mall 12 after accessing the online shopping mall 12 over the wired/wireless Internet 11 using an Internet accessible means, such as a Personal Computer (PC) 10-1 or the like, and purchasing a predetermined product, the online shopping mall 12 requests the online payment server 110-1 to process payment. The online payment server 110-1 directly generates card priority information, which includes optimum card information, in conjunction with the optimum card recommendation server 120-1, or receives the card priority information from the optimum card recommendation server 120-1, and thereafter provides the card priority information to the user via the online shopping mall 12.

In this embodiment, the online payment server 110-1 has the same operation and function as the POS terminal described in the above embodiments except for the fact that information about the combination card, such as a combination card ID, is directly received from the user through the PC 10-1, and thus a detailed description thereof is omitted.

Next, FIG. 8 is a network configuration diagram showing a combination card payment terminal according to an embodiment of the present invention.

A combination card payment terminal 400 proposed in the present invention is a portable terminal for storing information about a combination card, and enables the user to store and manage information about a plurality of cards carried by the user therein. The combination card payment terminal 400 may also store pieces of information required for the service of the present invention, for example, information about the benefits of respective cards, or an optimum card recommendation algorithm.

Methods of storing card information may be implemented using various methods, such as a method of reading and storing information of an inserted card using the combination card payment terminal 400 when the card is directly inserted therein, a method of reading and storing information through a card reader connected in a wired manner, a method of downloading card information to the PC through the Internet and storing the card information in the combination card payment terminal 400, and a method of downloading and storing card information over the wired/wireless Internet using the combination card payment terminal 400. Such a method is not limited in the present invention.

Meanwhile, the combination card payment terminal 400 provides the combination card information stored in internal memory to the POS terminal 110 while communicating with the POS terminal 110, thus enabling card payment to be used even if the user does not carry a separate card.

Further, as shown in FIG. 8, the combination card payment terminal 400 can independently execute the optimum card recommendation algorithm stored therein, without the help of the optimum card recommendation server or the POS terminal, thereby allowing the user to select an optimum card. When only card information is simply stored, a separate optimum card recommendation server or a separate POS terminal can be utilized, similar to the above embodiments.

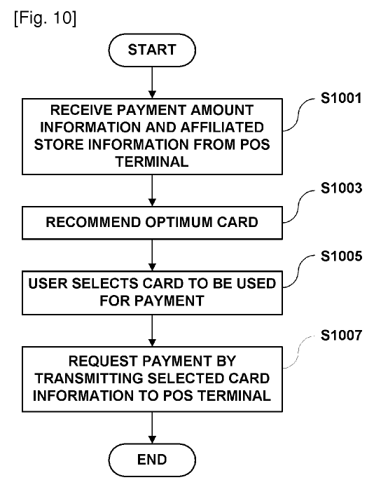

FIGS. 9 and 10 respectively illustrate a diagram showing the construction of a combination card payment terminal 400 and a flowchart showing the operation of the combination card payment terminal 400 when the combination card payment terminal 400 directly recommends an optimum card.

First, as shown in FIG. 9, the combination card payment terminal 400 includes a combination card information management unit 410, an optimum card recommendation unit 420, an update unit 430, memory 440, and a communication means 450.

The combination card information management unit 410 is a block for managing card information stored in the memory 440, and may be implemented using various methods depending on the above-described card information storage methods.

The optimum card recommendation unit 420 generates and outputs card priority information, which includes optimum card recommendation information, on the basis of information about the benefits of the respective cards and the optimum card recommendation algorithm, which are stored in the memory 440, and performs control such that when the user selects a card to be used for payment, information about the selected card is transmitted to the payment apparatus (POS terminal or the like) through the communication means 450.

Further, the optimum card recommendation unit 420 determines criteria by which the user selects a card on the basis of the information about the card selected by the user, manages priority information of the user for selection of a card according to the determined criteria, and generates card priority information by enabling the priority information of the user to be considered in an optimum card recommendation algorithm.

The update unit 430 is a block for downloading both the information about the benefits of the respective cards and the optimum card recommendation algorithm, which are stored in the memory 440, over the wired/wireless Internet, and updating them.

Further, in the memory 440, the information about the plurality of cards carried by the user, the information about the benefits of the respective cards, and the optimum card recommendation algorithm are stored. The communication means 450 may transmit information about the card, selected by the user from among pieces of information about the plurality of cards stored in the memory 440, to the payment apparatus, and may be provided with a wired/wireless Internet access function required for the updating of data.

Meanwhile, when an optimum card is not directly recommended, the combination card payment terminal 400 of the present invention may include only memory 440 for storing information about a plurality of cards carried by the user, and a communication means 450 for transmitting the information about the cards, stored in the memory, to the payment apparatus in response to a payment request received from the user.

The operation of the combination card payment terminal for directly executing the optimum card recommendation algorithm is described with reference to FIG. 10.

When the combination card payment terminal 400 receives payment amount information and affiliated store information from the POS terminal at step S1001, the combination card payment terminal 400 executes the optimum card recommendation algorithm by using the benefits of respective cards, the priority of the user, the payment amount information, the affiliated store information, etc. as input information, and then generates and outputs card priority information, which includes optimum card information, at step S1003.

When a card to be used for payment is selected by the user at step S1005, the combination card payment terminal 400 requests payment from the POS terminal by transmitting the information about the selected card to the POS terminal at step S1007. As described above, in the present invention, an optimum card may be a combination of a plurality of cards, and the card selected by the user may also include a plurality of cards.

In this case, the combination card payment terminal 400 updates the priority information of the user depending on the information about the selected card, and then recommends an optimum card by enabling the user priority information to be considered in the optimum card recommendation algorithm when the combination card of the user is subsequently used.

Since those skilled in the art can implement the present invention in other preferred embodiments without changing the technical spirit or essential features thereof, it should be understood that the above-described embodiments are not intended to limit the present invention, and are intended to exemplify the present invention in all aspects. The scope of the present invention is defined by the accompanying claims rather than the above detailed description, and the meaning and scope of the claims and all changes or modifications derived from equivalents thereof should be interpreted as being included in the scope of the present invention.

1. An artificial intelligence payment system for recommending an optimum card capable of providing a maximum benefit from among a plurality of cards, comprising:
a payment apparatus for receiving an Identification (ID) of a combination card, which enables a plurality of cards to be used as a single card, and information about a payment amount, transmitting the combination card ID and the payment amount information to an optimum card recommendation server, and receiving priority information based on benefits of a plurality of cards mapped to the combination card ID from the optimum card recommendation server; and
the optimum card recommendation server for generating card priority information, which includes optimum card recommendation information, on a basis of benefits of respective cards and a specific optimum card recommendation algorithm with respect to the plurality of user cards mapped to the combination card ID when the combination card ID and the payment amount information are received from the payment apparatus, and for providing the card priority information to the payment apparatus.

2. The artificial intelligence payment system according to claim 1, wherein the payment apparatus processes payment using an optimum card on a basis of the card priority information received from the optimum card recommendation server.

3. The artificial intelligence payment system according to claim 1, wherein the payment apparatus presents the card priority information, received from the optimum card recommendation server, to the user by outputting the card priority information, and then processes payment using a card selected by the user from among the plurality of cards.

4. The artificial intelligence payment system according to claim 3, wherein:
the payment apparatus transmits information about the card selected by the user to the optimum card recommendation server; and
the optimum card recommendation server determines criteria by which the user selects a card on a basis of the information about the card selected by the user, updates priority information of the user for selection of a card according to the criteria, and generates the card priority information for the user on a basis of an optimum card recommendation algorithm, in which the updated priority information of the user is considered.

5. An artificial intelligence payment system for recommending an optimum card capable of providing a maximum benefit from among a plurality of cards, comprising:
a payment apparatus for transmitting an ID of a combination card, which enables a plurality of cards to be used as a single card, to an optimum card recommendation server, and receiving information about a plurality of cards mapped to the combination card ID from the optimum card recommendation server when the combination card ID and information about a payment amount are input, and for generating card priority information, which includes optimum card recommendation information, on a basis of benefits of respective cards and a specific optimum card recommendation algorithm, with respect to the plurality of user cards; and
the optimum card recommendation server for providing the information about the plurality of user cards mapped to the combination card ID to the payment apparatus when the combination card ID is received from the payment apparatus.

6. The artificial intelligence payment system according to claim 5, wherein the payment apparatus processes payment using an optimum card on a basis of the generated card priority information.

7. The artificial intelligence payment system according to claim 5, wherein the payment apparatus presents the generated card priority information to the user by outputting the priority information, and then processes payment using a card selected by the user from among the plurality of cards.

8. The artificial intelligence payment system according to claim 7, wherein:
the payment apparatus transmits information about the card selected by the user to the optimum card recommendation server, and generates card priority information on a basis of an optimum card recommendation algorithm, in which priority information of the user is considered, when the priority information of the user is received together with the information about the plurality of cards mapped to a specific combination card ID from the optimum card recommendation server; and
the optimum card recommendation server determines criteria by which the user selects a card on a basis of the information about the card selected by the user, updates priority information of the user for selection of a card according to the criteria, and provides updated priority information of the user to the payment apparatus when the combination card ID of the user is subsequently received.

9. An artificial intelligence payment system for recommending an optimum card capable of providing a maximum benefit from among a plurality of cards, comprising:
a payment apparatus for obtaining information about a plurality of cards from a combination card, in which information about a plurality of cards is recorded, transmitting the obtained card information and information about a payment amount to an optimum card recommendation server, and receiving priority information based on benefits of respective cards from the optimum card recommendation server; and
the optimum card recommendation server for generating card priority information, which includes optimum card recommendation information, on a basis of the benefits of the respective cards and a specific optimum card recommendation algorithm with respect to the plurality of cards, and providing the card priority information to the payment apparatus when the information about the plurality of cards and the payment amount information are received from the payment apparatus.

10. The artificial intelligence payment system according to claim 9, wherein the payment apparatus processes payment using an optimum card on a basis of the card priority information received from the optimum card recommendation server, or processes payment using a card selected by the user from among the plurality of cards by presenting the card priority information, received from the optimum card recommendation server, to the user.

11. The artificial intelligence payment system according to claim 10, wherein:
the payment apparatus transmits the information about the card selected by the user to the optimum card recommendation server; and
the optimum card recommendation server determines criteria by which the user selects a card on a basis of the information about the card selected by the user, updates priority information of the user for selection of a card according to the criteria, and subsequently generates card priority information for the user on a basis of an optimum card recommendation algorithm in which the updated priority information of the user is considered.

12. An artificial intelligence payment system for recommending an optimum card capable of providing a maximum benefit from among a plurality of cards, comprising:
a payment apparatus for transmitting obtained information about a plurality of cards to an optimum card recommendation server and receiving priority information of a user for selection of a card from the optimum card recommendation server when the information about the plurality of cards is obtained from a combination card in which information about the plurality of cards is recorded, and information about a payment amount is received, and for generating card priority information, which includes optimum card recommendation information, on a basis of benefits of respective cards and an optimum card recommendation algorithm, in which the priority information of the user is considered; and
the optimum card recommendation server for providing the priority information of the user to the payment apparatus when the information about the plurality of cards is received from the payment apparatus.

13. The artificial intelligence payment system according to claim 12, wherein the payment apparatus processes payment using an optimum card on a basis of the generated card priority information, or processes payment using a card selected by the user from among the plurality of cards by presenting the generated card priority information to the user.

14. The artificial intelligence payment system according to claim 12, wherein:
the payment apparatus transmits information about the card used for payment among the plurality of cards to the optimum card recommendation server; and
the optimum card recommendation server determines criteria by which the user selects a card on a basis of the information about the card used for payment, updates priority information of the user for selection of a card according to the criteria, and provides the updated priority information of the user to the payment apparatus when the combination card of the user is subsequently used.

15. A payment apparatus for processing payment using a combination card, enabling a plurality of cards to be used as a single card, and recommending an optimum card capable of providing a maximum benefit from among a plurality of cards usable for a single combination card, wherein:
when information about a combination card and information about a payment amount are input, the payment apparatus presents card priority information, which includes optimum card recommendation information and is generated on a basis of benefits of respective cards and a specific optimum card recommendation algorithm with respect to the plurality of user cards usable for the combination card, to a user, and processes payment using a card selected by the user from among the plurality of user cards.

16. The payment apparatus according to claim 15, wherein the payment apparatus transmits the combination card information and the payment amount information to the specific optimum card recommendation server, receives the card priority information from the optimum card recommendation server, and presents the card priority information to the user.

17. The payment apparatus according to claim 16, wherein the payment apparatus transmits information about the card used for payment to the optimum card recommendation server, and receives card priority information, based on an optimum card recommendation algorithm, in which priority information of the user for selection of a card according to the card information selected by the user is considered, from the optimum card recommendation server when the combination card of the user is subsequently used.

18. The payment apparatus according to claim 15, wherein the payment apparatus stores the optimum card recommendation algorithm, and directly generates the card priority information.

19. The payment apparatus according to claim 18, wherein the payment apparatus transmits the information about the card used for payment to the optimum card recommendation server, and receives priority information of the user for selection of a card according to the card information selected by the user from the optimum card recommendation server when the combination card of the user is subsequently used, and then generates card priority information on a basis of an optimum card recommendation algorithm in which the priority information is considered.

20. A combination card payment terminal of a user for using a payment apparatus for recommending an optimum card capable of providing a maximum benefit from among a plurality of cards carried by the user, comprising:
memory for storing information about the plurality of cards carried by the user; and
communication means for transmitting the information about the plurality of cards, stored in the memory, to the payment apparatus in response a payment request received from the user,
wherein the combination card payment terminal enables an optimum card recommended by the payment apparatus, among the plurality of cards, to be used for payment.

21. A combination card payment terminal of a user for recommending an optimum card capable of providing a maximum benefit from among a plurality of cards carried by the user, comprising:
memory for storing information about the plurality of cars carried by the user, information about benefits of respective cards, and a predetermined optimum card recommendation algorithm;
communication means for transmitting information about a card selected by the user among pieces of information about the plurality of cards, stored in the memory, to a payment apparatus;
a combination card information management unit for managing the card information stored in the memory; and
an optimum card recommendation unit for generating and outputting card priority information, which includes optimum card recommendation information, on a basis of the information about the benefits of respective cards and the optimum card recommendation algorithm, which are stored in the memory, and performing control such that, when the user selects a card to be used for payment, information about the selected card is transmitted to the payment apparatus through the communication means,
wherein the combination card payment terminal enables an optimum card selected from among the plurality of cards to be used for payment.

22. The combination card payment terminal according to claim 21, wherein the optimum card recommendation unit determines criteria by which the user selects a card on a basis of the information about the card selected by the user, manages priority information of the user for selection of a card according to the criteria, and generates card priority information by enabling the priority information of the user to be considered in the optimum card recommendation algorithm.

23. The combination card payment terminal according to claim 21, wherein the combination card payment terminal further comprises an update unit for downloading the information about the benefits of respective cards and the optimum card recommendation algorithm, which are stored in the memory, over wired/wireless Internet, and updating the downloaded information and algorithm.

24. The artificial intelligence payment system according to claim 13, wherein:
the payment apparatus transmits information about the card used for payment among the plurality of cards to the optimum card recommendation server; and
the optimum card recommendation server determines criteria by which the user selects a card on a basis of the information about the card used for payment, updates priority information of the user for selection of a card according to the criteria, and provides the updated priority information of the user to the payment apparatus when the combination card of the user is subsequently used.

25. The combination card payment terminal according to claim 22, wherein the combination card payment terminal further comprises an update unit for downloading the information about the benefits of respective cards and the optimum card recommendation algorithm, which are stored in the memory, over wired/wireless Internet, and updating the downloaded information and algorithm.
